(19) United States
(12) Patent Application Publication
(10) Pub. No.: US 2007/0130364 A1
(43) Pub. Date: Jun. 7, 2007

(54) Techniques to determine an integrity validation value

(75) Inventors: Abhijeet Joglekar, Hillsboro, OR (US); Steven R. King, Portland, OR (US); Frank L. Berry, North Plains, OR (US); Parthasarathy Sarangam, Portland, OR (US); Srihari Makineni, Portland, OR (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/292,770

(22) Filed: Dec. 2, 2005

(51) Int. Cl. G06F 15/173

(52) U.S. Cl. 709/238

(57) ABSTRACT

Techniques are described herein that may be used to instruct a network component to determine an integrity validation value over information as well as when to include the determined integrity validation value in a network protocol unit to be transmitted. For example, in some implementations, the network component may generate a cyclical redundancy checking (CRC) value. The value may be determined by the network component across multiple segments of information and independent of the utilized protocol.

### FIELD

The subject matter disclosed herein relates to techniques to determine an integrity validation value that could be used to verify integrity of information.

### RELATED ART

Data communications systems typically utilize techniques to verify the integrity of transferred information. In some cases, packets may be transmitted with an integrity value computed over the contents and the value can be used by the receiver of the packets to check the integrity of the packet. For example, to verify integrity of received packets, various protocols such as Remote Direct Memory. Access (RDMA), Internet Small Computer System. Interface (iSCSI), and Stream Control. Transmission Protocol (SCTP) may use a calculation of cyclical redundancy checking (CRC) values over received packets as well as a comparison of calculated CRC values with CRC values provided with the packets. For example, RDMA is described at www.rdmaconsortium.com as well as in An RDMA Protocol Specification, Version 1.0 (October 2002). iSCSI is described for example at RFC 3720: Internet Small Computer Systems Interface (iSCSI) (April 2004). SCTP is described for example at The Internet Society RFC-3286, An Introduction to the Stream Control Transmission Protocol (SCTP) (May 2002).

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 depicts in block diagram form a computer system, in accordance with some embodiments of the present invention.

FIG. 2 depicts a block diagram of logic elements that can be used to determine an integrity validation value in a network component, in accordance with some embodiments of the present invention.

FIGS. 3A to 3C depict examples in accordance with some embodiments of the present invention.

FIG. 4 shows an example of segments transmitted over multiple network protocol units.

FIG. 5 depicts a flow diagram of an example process that can be used in embodiments of the present invention.

Note that use of the same reference numbers in different figures indicates the same or like elements.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

In some embodiments, an iSCSI Protocol Data Unit (PDU) starts with a 48-byte header followed by a 4-byte header CRC value. In some embodiments, the header CRC value is followed by a data segment consisting of 0 to a maximum PDU size of data (the maximum PDU size may be 8-kilobytes), followed by pad bytes, and a 4-byte data CRC value. If markers are enabled, then the PDU may also contain marker bytes at fixed intervals (4 kilobyte intervals for instance).

In some embodiments, an iSCSI stack creates the iSCSI PDU header and fills in the protocol fields. In some embodiments, the iSCSI stack creates a scatter-gather list (SGL) with scatter-gather elements (SGEs) pointing to the header, the data, any markers in the data, and the pad bytes.

In some known techniques, the iSCSI stack, in software, determines separate CRC values on the header and the data, and adds the computed CRC values to the SGL.

Some embodiments of the present invention enable the iSCSI stack (or other logic) to instruct a network component to determine integrity validation values for segments of a PDU or other information. An “integrity validation value” may be a CRC value, checksum, as well as other values determined based on information. The determined integrity validation values may be included in a network protocol unit transmitted from the network component. As used herein, a “network protocol unit” may include any packet or frame or other format of information with a header and payload portions formed in accordance with any protocol specification.

In some embodiments, the host may include at least two flags in a descriptor that is provided to a network component to instruct the network component to: (1) determine an integrity validation value over a portion of information and/or (2) insert a determined integrity validation value in a data stream after a current segment of information. The descriptor may be a TCP Large Send Offload (LSO) descriptor. For example, TCP LSO is described at least in Regnier, Makineni, et al, “TCP Onloading for Datacenter Server: Perspectives and Challenges”, IEEE Computer Magazine, Vol. 37, No. 11, pg 48-58, November 2004 and Freimuth, Hu, “Server Network Scalability and TCP Offload”, Proceedings of the USENIX Annual Technical Conference, General Track, 2005.

Although not a necessary feature of any embodiment, some embodiments may reduce or avoid eviction of other useful information from the host cache.

Some embodiments permit the network component to determine integrity validation values during transfer of information from the host to the network component for transmission, thereby potentially enabling higher throughput while lowering the host processor utilization. For example, some embodiments permit determination of the integrity validation values on information that a data mover of the network component transfers from the buffers in the host to the network component for transmission.

In some embodiments, the network component does not need to be aware of the protocol that is used (e.g., iSCSI) or of the PDU format, for generating integrity validation values. Instructions to the network component described earlier concerning flags can be used to compute integrity validation values. Some embodiments can be used for any protocol that determines integrity validation values for data integrity validation purposes.

Some embodiments of the present invention may permit an integrity validation value to be determined on iSCSI PDUs split over multiple TCP segments. Some embodiments of the present invention may permit an integrity validation value to be determined over iSCSI PDUs split over multiple TCP LSOs or over multiple TCP transmit requests to the network component.

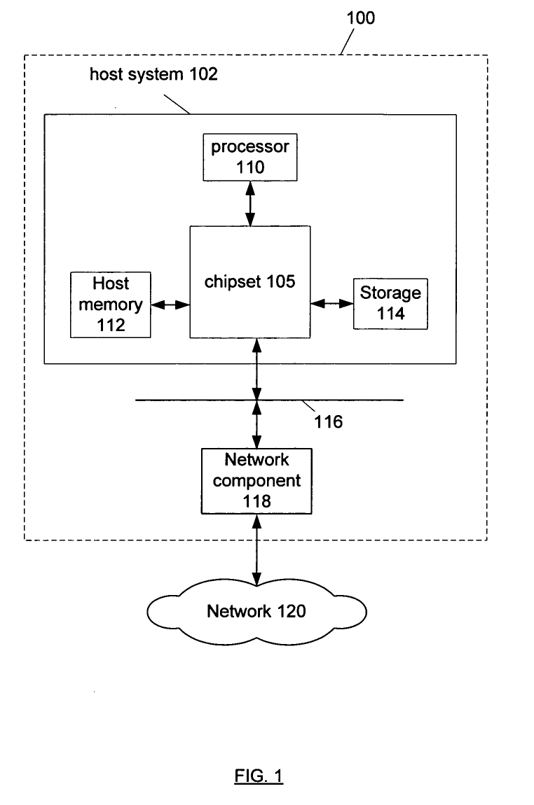

FIG. 1 depicts in block diagram form a computer system 100. Computer system 100 is a suitable system in which some embodiments of the present invention may be used. Computer system 100 may include host system 102, bus 116, and network component 118.

Host system 102 may include chipset 105, processor 110, host memory 112, and storage 114. Chipset 105 may provide intercommunication among processor 110, host memory 112, storage 114, bus 116, as well as a graphics adapter that can be used for transmission of graphics and information for display on a display device (both not depicted). For example, chipset 105 may include a storage adapter (not depicted) capable of providing intercommunication with storage 114. For example, the storage adapter may be capable of communicating with storage 114 in conformance with any of the following protocols: Small Computer Systems Interface (SCSI), Fibre Channel (FC), and/or Serial Advanced Technology Attachment (S-ATA).

In some embodiments, chipset 105 may include data mover logic capable of performing transfers of information within host memory 112, or between network component 118 and host memory 112, or in general between any set of components in the computer system 100. As used herein, a “data mover” refers to a module for moving data from a source to a destination without using the core processing module of a host processor, such as processor 110, or otherwise does not use cycles of a processor to perform data copy or move operations. By using the data mover for transfer of data, the processor may be freed from the overhead of performing data movements. A data mover may include, for example, a direct memory access (DMA) engine as described herein. In some embodiments, data mover could be implemented as part of processor 110, although other components of computer system 100 may include the data mover.

Processor 110 may be implemented as Complex Instruction Set Computer (CISC) or Reduced Instruction Set Computer (RISC) processors, multi-core, or any other microprocessor or central processing unit. Host memory 112 may be implemented as a volatile memory device such as but not limited to a Random Access Memory (RAM), Dynamic Random Access Memory (DRAM), or Static RAM (SRAM). Storage 114 may be implemented as a non-volatile storage device such as but not limited to a magnetic disk drive, optical disk drive, tape drive, an internal storage device, an attached storage device, flash memory, battery backed-up SDRAM (synchronous DRAM), and/or a network accessible storage device.

Bus 116 may provide intercommunication among at least host system 102 and network component 118 as well as other peripheral devices (not depicted). Bus 116 may support serial or parallel communications. Bus 116 may support node-to-node or node-to-multi-node communications. Bus 116 may be compliant with Peripheral Component Interconnect (PCI) described for example at Peripheral Component Interconnect (PCI) Local Bus Specification, Revision 2.2, Dec. 18, 1998 available from the PCI Special Interest Group, Portland, Oreg., U.S.A. (as well as revisions thereof); PCI Express described in The PCI Express Base Specification of the PCI Special Interest Group, Revision 1.0a (as well as revisions thereof); PCI-x described in the PCI-X Specification Rev. 1.0a, Jul. 24, 2000, available from the aforesaid PCI Special Interest Group, Portland, Oreg., U.S.A. (as well as revisions thereof); and/or Universal. Serial Bus (USB) (and related standards) as well as other interconnection standards.

Network component 118 may be capable of providing intercommunication between host system 102 and network 120 in compliance with any applicable protocols. Network component 118 may intercommunicate with host system 102 using bus 116. In one embodiment, network component 118 may be integrated into chipset 105. “Network component” may include any combination of digital and/or analog hardware and/or software on an I/O (input/output) subsystem that may process one or more network protocol units to be transmitted and/or received over a network. In one embodiment, the I/O subsystem may include, for example, a network component card (NIC), and network component may include, for example, a MAC (media access control) layer of the Data Link Layer as defined in the Open System Interconnection (OSI) model for networking protocols. The OSI model is defined by the International Organization for Standardization (ISO) located at 1 rue de Varembé, Case postale 56 CH-1211 Geneva 20, Switzerland.

Some embodiments of network component 118 may include the capability to determine integrity validation values for portions of information to be transmitted to a network. For example, the information may include segments of a PDU. Descriptors transferred from host system 102 to network component 118 may instruct logic in the network component 118 whether to use the portion of information in determining an integrity validation value and whether to append a determined integrity validation value after the portion of information.

Network 120 may be any network such as the Internet, an intranet, a local area network (LAN), storage area network (SAN), a wide area network (WAN), or wireless network. Network 120 may exchange traffic with network component 118 using the Ethernet standard (described in IEEE 802.3 and related standards) or any communications standard.

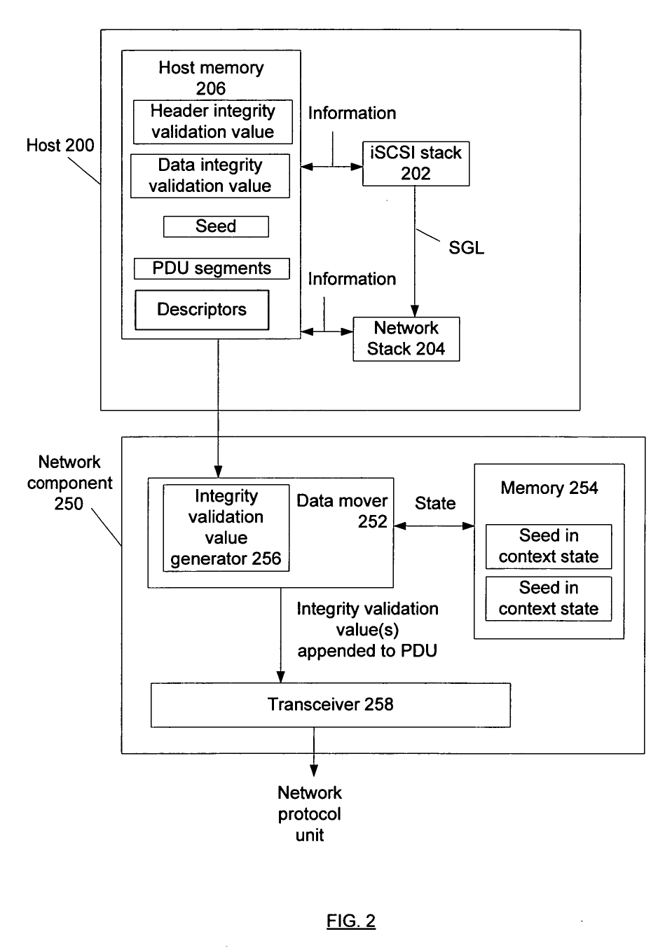

FIG. 2 depicts a block diagram of logic elements that can be used to determine an integrity validation value in a network component, in accordance with some embodiments of the present invention. Host 200 may include iSCSI stack 202, network stack 204, host memory 206, as well as other logic that is not depicted such as but not limited to a processor and other input/output logic such as a bus.

iSCSI stack 202 may create an iSCSI PDU header and fill in all the protocol fields for the PDU. The iSCSI stack may also create a scatter-gather list (SGL) with scatter-gather elements (SGEs) pointing to the header, the data, any markers in the data, and pad bytes. For example, each SGE may include: (1) an address in host memory 206 and length of information to which the SGE refers; (2) a compute (“C”) flag; and (3) an append (“A”) flag. For example, the information may include a PDU segment. For example, a SGE may be provided for each segment of a PDU. For example, there may be a header SGE, data SGE, and pad SGE.

In some embodiments, by using the C and A flags, an iSCSI stack can control whether a network component determines an integrity validation value over a PDU segment, and can control a position in a transmission stream where the network component inserts a determined integrity validation value. In some embodiments, any protocol other than iSCSI may be used.

In some embodiments, when the C flag is 1, network component 250 determines an incremental integrity validation value over the segment pointed to by a descriptor; whereas when the C flag is 0, network component 250 does not consider the segment pointed to by this descriptor during incremental integrity validation value determination.

In some embodiments, when the A flag is 1, network component 250 appends the current determined integrity validation value after the segment pointed to by the descriptor and may reset its integrity validation value to the initial value; whereas when the A flag is 0, network component 250 does not append the current integrity validation value after the PDU segment pointed to by the descriptor but may carry forward the integrity validation value for incremental integrity validation value determination.

Network stack 204 may convert SGEs into TCP LSOs or other formats. Network stack 204 may incorporate instructions from C and A flags from each SGE into the TCP LSO. In some embodiments, network stack 204 may include an integrity validation seed value in the TCP LSO. A TCP LSO may refer to a sequence of descriptors that point to the template TCP header and the TCP payload SGL and may incorporate C and A flags described earlier.

In some embodiments, network stack 204 may be compliant with TCP/IP. For example, the TCP/IP protocol is described at least in the publication entitled “Transmission Control Protocol: DARPA Internet Program Protocol Specification,” prepared for the Defense Advanced Projects Research Agency (RFC 793, published September 1981).

Host memory 206 may at least store descriptors (e.g., provided by network stack 204) as well as other information such as but not limited to segments of PDUs as well as header and/or data integrity validation values determined by network component 250 and transmitted in a network protocol unit. Host memory 206 may also store integrity validation seed values.

In some embodiments, a network component 250 includes data mover 252, memory 254, integrity validation value generator 256, and transceiver 258. Data mover 252 may read at least one TCP LSO from host 200. For example, network component 250 may poll for at least one new TCP LSO from host memory 206 or may receive a request (e.g., interrupt) to retrieve at least one new TCP LSO from host memory 206. The TCP LSO may refer to descriptors stored in host memory 206. Based on the TCP LSO, data mover 252 may locate and retrieve associated descriptors from host memory 206. Based on the descriptors, data mover 252 may locate and retrieve associated PDU segments from host memory 206.

Integrity validation value generator 256 may be implemented among the same logic as data mover 252. In some embodiments, integrity validation value generator 256 may be implemented in a separate logic from the data mover logic. In some embodiments, the descriptors retrieved by data mover logic control operations of integrity validation value generator 256. Based on instructions from C and A flags transferred in the TCP LSO, integrity validation value generator 256 may determine integrity validation values and/or append a determined integrity validation value.

In some embodiments, integrity validation value generator 256 may determine an integrity validation value over each segment for which a C flag indicates an integrity validation value should be determined over the segment. Integrity validation value generator 256 may append the determined integrity validation value after the segment for which the A flag indicates that the integrity validation value is to be appended after the PDU segment. In some embodiments, determination of an integrity validation value may use table look-ups, arithmetic-logic-unit operations, and/or calculations.

TCP may split the transmission of a single iSCSI PDU into multiple transmit requests (for example into multiple TCP LSOs). In order for integrity validation value generator 256 to determine an integrity validation value, availability of the entire ISCSI PDU may be desirable. In some cases, a single LSO describes an entire PDU completely. However, in some cases, processing of an iSCSI PDU is described across multiple LSOs. In some cases, it is desirable to use an integrity validation value determined for a PDU segment as an integrity validation seed value for determination of an integrity validation value of a next segment of the PDU regardless of when the PDU is described in more than one LSO.

For a first segment of a PDU, an initialization seed may be used by network component 250 as a seed value. For example, the initialization seed may be stored in host memory 206 or memory 254 in network component 250. For example, the initialization seed may be defined by a relevant standard such as but not limited to iSCSI.

An integrity validation value determined for a segment may be used as a seed for a next segment. For example, for a PDU to be processed over multiple LSOs, a determined integrity validation value for a portion of the PDU may be used as a seed value for another part of the PDU. In some implementations, an integrity validation value determined for an LSO may be used as a seed value for a subsequent LSO.

In some embodiments, network stack 204 tracks where the integrity validation seed value is located (e.g., location in host memory 206 and/or location in memory 254). In some embodiments, the stack knows whether an integrity validation seed value is in memory of network component 250 because the stack controls writes to memory of network component 250. In some embodiments, network stack 204 may track whether network component 250 should use an integrity validation value determined from a previous LSO as a seed value.

In some embodiments, an integrity validation seed value is stored in a relevant context state for the connection in memory 254 of network component. The context state may indicate connection information such as but not limited to TCP state.

Network stack 204 may instruct network component 250 through an LSO whether to retrieve a seed from host memory 206 or memory 254 in network component 250. For example, in FIG. 2, the seed is shown as “Seed” (in host memory 206) and “Seed in context state” (in memory 254). For example, host 200 may use a TCP LSO control descriptor to provide an integrity validation seed value to network component 250, a control descriptor to provide a pointer to an integrity validation seed value in host memory 206, or a control descriptor to provide a pointer to a location in a memory location in memory 254 of network component 250 of an integrity validation seed value.

In some embodiments, after completion of processing each LSO, network component 250 may store a determined integrity validation value into memory 254 in network component 250. After completion of processing each LSO, network component 250 may transfer an LSO completion descriptor to network stack 204 indicating completion of the LSO as well as providing the determined integrity validation value. In some embodiments, network stack 204 may instruct network component 250 where to store the determined integrity validation value in host memory 206.

Writing back the determined integrity validation value to host memory 206 may be useful during segmentation of PDUs as well as in the case of TCP retransmission. In some instances, Ethernet packets are lost and a transmitter of packets is to retransmit lost packets. If a PDU is transmitted over multiple Ethernet packets, and the last or one of the last of the multiple Ethernet packets is lost or corrupted, then an integrity validation value may need to be retransmitted. However, the PDU segments over which the integrity validation value was determined may not be stored by the transmitter. In some embodiments, the header integrity validation value and/or data integrity validation value determined over segments of the PDU may be stored into host or network component memory. Accordingly, if a packet with a header or data integrity validation value for at least one PDU is to be re-transmitted then the header or data integrity validation value is available to be re-transmitted.

In some embodiments, the header and/or data integrity validation value is stored in host memory 206 until an acknowledgement message is received from the receiver of the Ethernet packet that contained the header or data integrity validation value. For example, in FIG. 2, a stored header integrity validation value is shown as “Header integrity validation value” whereas a stored data integrity validation value is shown as “Data integrity validation value”. In some embodiments, the header and/or data integrity validation value may be stored in memory 254.

After receiving an acknowledgement message, the header and/or data integrity validation value in the Ethernet packet that contained the relevant header and/or data integrity validation value stored in host memory 206 and for which an acknowledgement message was received may be available to be overwritten. Writing the integrity validation value to memory may ensure that TCP segment is retransmitted with the correct iSCSI integrity validation value. Network stack 204 may keep track of the current integrity validation value for each iSCSI payload while it is transmitted.

Data mover 252 may provide to transceiver 258 PDU segments along with inserted integrity validation values determined by integrity validation value generator 256. Transceiver 258 may include a media access controller (MAC) and a physical layer interface (both not depicted) capable of receiving packets from a network and transmitting packets to a network in conformance with the applicable protocols such as Ethernet as described in IEEE 802.3, although other protocols may be used. Transceiver 258 may receive and transmit packets from and to a network via a network medium.

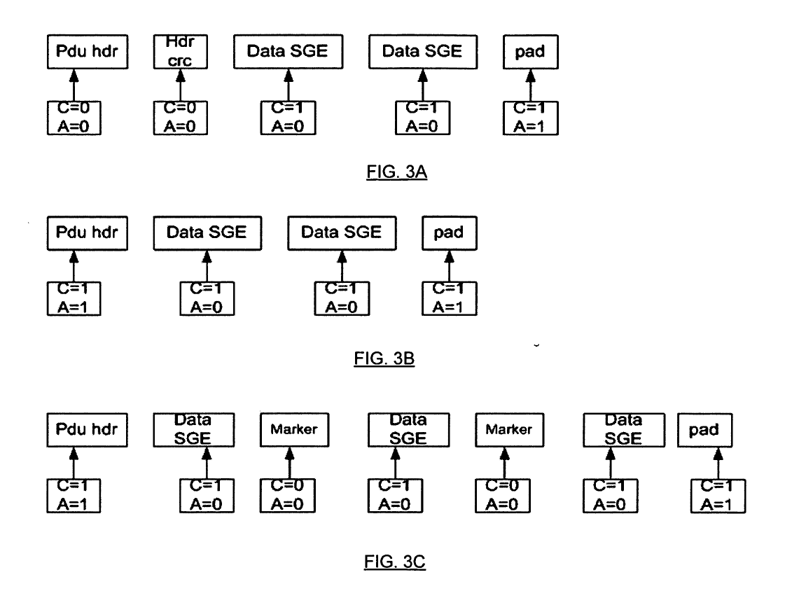

FIG. 3A depicts an example in which a data integrity validation value is generated by a network component over multiple segments of a PDU. In this example, C and A flags are zero for the PDU header and header integrity validation value. The C flag being zero indicates that no integrity validation value is to be determined over the PDU header and header integrity validation value. The A flag being zero indicates that no integrity validation value is to be appended after any of the PDU header and header integrity validation value. In this example, a header integrity validation value may have been generated in a host by a TCP stack or iSCSI stack or by another source.

In this example, the C flag is set to 1 whereas the A flag is set to 0 for two consecutive data scatter gather element (SGE) segments of the PDU. Accordingly, a integrity validation value is determined over the two consecutive data SGEs. In other examples, an integrity validation value may be determined over other numbers of SGEs. Further, the C and A flags are set to 1 for the PDU pad segment. Accordingly, an integrity validation value is further determined over the PDU pad segment and the determined integrity validation value is appended after the PDU pad segment. In this example, the integrity validation value may be determined over the two consecutive data SGEs as well as the pad segment and appended after the PDU pad segment for transmission.

In some embodiments, the integrity validation value determined over the first data SGE is provided as a seed value for determining an integrity validation value over the second data SGE. The integrity validation value determined for the second data SGE may be provided as a seed value for determining the integrity validation value of the pad.

FIG. 3B depicts an example in which both data integrity validation value and header integrity validation value are generated by a network component. In this example, the C flag is set to 1 and the A flag is set to 1 for the PDU header so that a integrity validation value (header integrity validation value) is determined over the PDU header and appended after the PDU header for transmission. In this example, the C flag is set to 1 whereas the A flag is set to 0 for the two consecutive data SGEs. The C and A flags are set to 1 for the PDU pad segment. A integrity validation value may be determined over the two consecutive data SGEs and the PDU pad segment and appended after the PDU pad segment in a similar manner as that described with regard to FIG. 3A.

FIG. 3C depicts an example in which a data integrity validation value and header integrity validation value are generated by a network component but markers present in a PDU are not considered during determination of the integrity validation values. In this example, the C flag is set to 1 and the A flag is set to 1 for the PDU header so that an integrity validation value (header integrity validation value) is determined over the PDU header and appended after the PDU header for transmission. In this example, the C flag is set to 1 whereas the A flag is set to 0 for the two data SGEs but the C and A flags are set to 0 for the marker between the two data SGEs and for the marker following the second data SGE. The C and A flags are set to 1 for the PDU pad segment. An integrity validation value may be determined over the two data SGEs and the PDU pad segment and appended after the PDU pad segment in a similar manner as that described with regard to FIG. 3A. In this example, the markers are not considered during the determination of any integrity validation value.

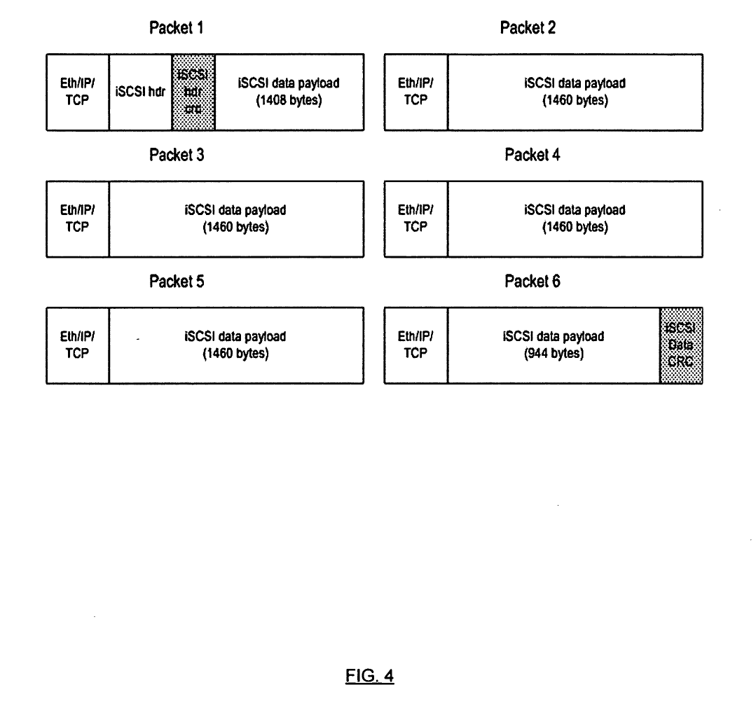

FIG. 4 shows an example of PDU segments transmitted over multiple Ethernet packets. FIG. 4 shows the TCP packets on a wire generated by the network component for an iSCSI PDU with the header and data integrity validation value selectively determined by a network component inserted into appropriate positions in the stream. The example of FIG. 4 shows an 8 kilobyte iSCSI PDU with no markers and a TCP payload of maximum 1460 bytes per Ethernet frame.

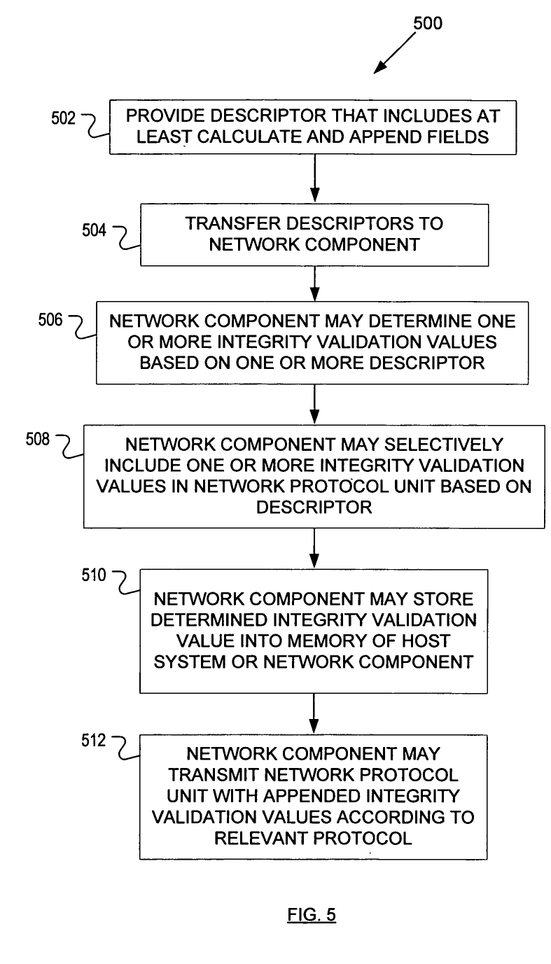

FIG. 5 depicts a flow diagram of an example process 500 that can be used in embodiments of the present invention. For example, process 500 can be used by the logic described with respect to FIG. 2 to compute integrity validation values and to request transmission of network protocol units with the computed integrity validation values.

In block 502, logic used by a host computer may provide a descriptor that at least identifies PDU segments by starting address and length in a memory as well as include at least calculate and append fields and may include a seed. For example, such logic may be a TCP stack or iSCSI compliant stack or other logic compatible with other protocols. For example, the calculate field may instruct logic in the network component whether to use the portion of information in determining a integrity validation value whereas the append field may instruct logic in the network component whether to append the integrity validation value after the portion of information. In some embodiments, the descriptor may also include or identify a location of a seed value to use to determine the integrity validation value.

In block 504, the logic may transfer the descriptors to the network component. In some embodiments, a data mover logic of the network component may transfer the descriptors from the host computer to the network component.

In block 506, the network component may determine one or more integrity validation values based on one or more descriptor. For example, the calculate field of the descriptor may be used to indicate whether the network component is to determine an integrity validation value over a segment of information. For example, the integrity validation value may be a CRC value, although other values may be determined. For example, the information may include a portion of a PDU that is to be transmitted to a receiver through a network.

In block 508, the network component may selectively insert one or more integrity validation values for a network protocol unit based on the descriptor. For example, the append field of the descriptor may be used to indicate whether a determined integrity validation value is to be inserted after the portion of information. For example, an integrity validation value may be determined over multiple segments of information and appended after multiple segments of information.

In block 510, the network component may store the determined integrity validation value into memory of the host system or the network component. For example, the stored integrity validation value may be used as a seed for subsequent determination of an integrity validation value. For example, the stored integrity validation value may be transmitted in the event a retransmit of the determined integrity validation value is requested.

In block 512, the network component may transmit a network protocol unit with appended integrity validation values according to the relevant protocol. Any protocol may be used such as but not limited to Ethernet.

Embodiments of the present invention may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method comprising:
issuing an instruction from a host to a network component, wherein:
the host comprises a processor and memory,
the network component comprises a memory and logic to determine an integrity validation value, and
the instruction includes at least:
a first instruction of whether the network component is to determine an integrity validation value over a portion of information, and
a second instruction of where the network component is to insert the determined integrity validation value in a network protocol unit that includes the information.

2. The method of claim 1, further comprising:
transferring information from the host to the network component using a data mover; and
determining the integrity validation value during the transfer by the data mover.

3. The method of claim 1, further comprising transmitting the network protocol unit that includes an integrity validation value determined based on the first and second instructions.

4. The method of claim 1, further comprising:
at the network component, determining the integrity validation value independent of network protocol; and
at the network component, including the determined integrity validation value in a network protocol unit independent of network protocol.

5. The method of claim 1, further comprising:
storing the determined integrity validation value into host memory; and
including the stored integrity validation value in a retransmitted network protocol unit.

6. The method of claim 1, further comprising:
writing a determined integrity validation value to host memory, wherein the determined integrity validation value is used as a seed in a subsequent instruction.

7. The method of claim 1, further comprising:
writing a determined integrity validation value to an address location in the memory of the network component, wherein the determined integrity validation value is used as a seed in a subsequent instruction.

8. The method of claim 1, wherein the instruction further provides a seed value from host memory.

9. The method of claim 6, wherein the instruction further provides a seed value from host memory.

10. The method of claim 1, wherein the instruction further provides an address location in the memory of the network component where a seed value is stored.

11. The method of claim 7, wherein the instruction further provides an address location in the memory of the network component where the seed value is stored.

12. The method of claim 1, further comprising:
at the network component, determining the integrity validation value of an iSCSI protocol data unit over multiple TCP segments.

13. The method of claim 1, further comprising:
at the network component, determining the integrity validation value of an iSCSI protocol data unit over multiple TCP transmit requests to the network component.

14. A computer-readable medium that stores instructions which when executed by a machine cause the machine to:
issue an instruction from a host to a network component, wherein the instruction includes at least:
a first instruction of whether the network component is to determine an integrity validation value over a portion of information, and
a second instruction of where the network component is to include the determined integrity validation value in a network protocol unit that includes the information.

15. The medium of claim 14, wherein the instructions further comprise instructions, which when executed by a machine cause the machine to:
at the network component, transmit the network protocol unit that includes an integrity validation value determined based on the first and second instructions.

16. The medium of claim 14, wherein the instructions further comprise instructions, which when executed by a machine cause the machine to:
store the determined integrity validation value into host memory; and
include the stored integrity validation value in a retransmitted network protocol unit.

17. The medium of claim 14, wherein the instructions further comprise instructions, which when executed by a machine cause the machine to:
write a determined integrity validation value to host memory, wherein the determined integrity validation value is used as a seed in a subsequent instruction.

18. The medium of claim 14, wherein the instructions further comprise instructions, which when executed by a machine cause the machine to:
write a determined integrity validation value to an address location in the memory of the network component, wherein the determined integrity validation value is used as a seed in a subsequent instruction.

19. The medium of claim 14, wherein the instructions further comprise instructions, which when executed by a machine cause the machine to provide a seed value from host memory to the network component.

20. The medium of claim 14, wherein the instructions further comprise instructions, which when executed by a machine cause the machine to provide an address location in the memory of the network component of where a seed value is stored.

21. An apparatus comprising:
a host comprising a processor and memory; and
a network component comprising a memory and logic to determine an integrity validation value, wherein the host issues an instruction to the network component and wherein the instruction includes at least:
a first instruction of whether the network component is to determine an integrity validation value over a portion of information, and
a second instruction of where the network component is to include the determined integrity validation value in a network protocol unit that includes the information.

22. The apparatus of claim 21, wherein the network component further comprises logic to transmit the network protocol unit that includes an integrity validation value determined based on the first and second instructions.

23. The apparatus of claim 21, further comprising:
logic to store the determined integrity validation value into host memory; and
logic to include the stored integrity validation value in a retransmitted network protocol unit.

24. The apparatus of claim 21, further comprising logic to write a determined integrity validation value to host memory, wherein the determined integrity validation value is used as a seed in a subsequent instruction.

25. The apparatus of claim 21, further comprising logic to write a determined integrity validation value to an address location in the memory of the network component, wherein the determined integrity validation value is used as a seed in a subsequent instruction.

26. The apparatus of claim 21, wherein the instruction further provides a seed value from host memory.

27. The apparatus of claim 21, wherein the instruction further provides an address location in the memory of the network component where a seed value is stored.

28. A system comprising:
a host comprising a processor and memory;
a storage device communicatively coupled to the host computer; and
a network component comprising a memory and logic to determine an integrity validation value, wherein the host issues an instruction to the network component and wherein the instruction includes at least:
a first instruction of whether the network component is to determine an integrity validation value over a portion of information, and
a second instruction of where the network component is to include the determined integrity validation value in a network protocol unit that includes the information.

29. The system of claim 28, wherein the network component further comprises logic to transmit the network protocol unit that includes an integrity validation value determined based on the first and second instructions.

30. The system of claim 28, further comprising:
logic to store the determined integrity validation value into host memory; and
logic to include the stored integrity validation value in a retransmitted network protocol unit.

31. The system of claim 28, further comprising logic to write a determined integrity validation value to host memory, wherein the determined integrity validation value is used as a seed in a subsequent instruction.

32. The system of claim 28, further comprising logic to write a determined integrity validation value to an address location in the memory of the network component, wherein the determined integrity validation value is used as a seed in a subsequent instruction.
